(19) United States
(12) Patent Application Publication
(10) Pub. No.: US 2026/0000126 A1
(43) Pub. Date: Jan. 1, 2026

(54) AEROSOL-GENERATING DEVICE

(71) Applicant: KT&G CORPORATION, Daejeon (KR)

(72) Inventors: Taehun KIM, Yongin-si Gyeonggi-do (KR); Jueon PARK, Seoul (KR)

(73) Assignee: KT&G CORPORATION, Daejeon (KR)

(21) Appl. No.: 18/695,609

(22) PCT Filed: Oct. 14, 2022
(86) PCT No.: PCT/KR2022/015638

§ 371 Date: Mar. 26, 2024

(30) Foreign Application Priority Data
Oct. 20, 2021 (KR) 10-2021-0140606
Jan. 19, 2022 (KR) 10-2022-0007997

(51) Int. Cl. A24F 40/51; A24F 40/20; A24F 40/465; H05B 6/10

(52) U.S. Cl. CPC A24F 40/51; A24F 40/20; A24F 40/465; H05B 6/108

(57) ABSTRACT

An aerosol-generating device is disclosed. The aerosol-generating device of the disclosure includes a pipe configured to define an insertion space; a heater configured to heat the insertion space; a substrate having a sensor pattern mounted thereon which is configured to sense an electromagnetic change of a surrounding region; and a connector configured to electrically connect the heater and the substrate, wherein the connector allows the heater to sense electromagnetic change of a surrounding region of the heater.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to increase a sensing area using a heater or an induction coil without an additional sensor device.

It is still another object of the present disclosure to improve the efficiency in use of space in a device.

It is still another object of the present disclosure to improve the efficiency in a process of manufacturing a device or manufacturing costs thereof.

### Solution to Problem

In accordance with an aspect of the present disclosure for accomplishing the above and other objects, there is provided an aerosol-generating device including a pipe configured to define an insertion space; a heater configured to heat the insertion space; a substrate having a sensor pattern mounted thereon which is configured to sense an electromagnetic change of a surrounding region; and a connector configured to electrically connect the heater and the substrate, wherein the connector allows the heater to sense electromagnetic change of a surrounding region of the heater.

### Advantageous Effects of Invention

According to at least one of embodiments of the present disclosure, it may be possible to increase a sensing area using a heater or an induction coil without an additional sensor device.

According to at least one of embodiments of the present disclosure, it may be possible to improve the efficiency in use of space in a device.

According to at least one of embodiments of the present disclosure, it may be possible to improve the efficiency in a process of manufacturing a device or manufacturing costs thereof.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

FIGS. 1 to 9 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

With respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

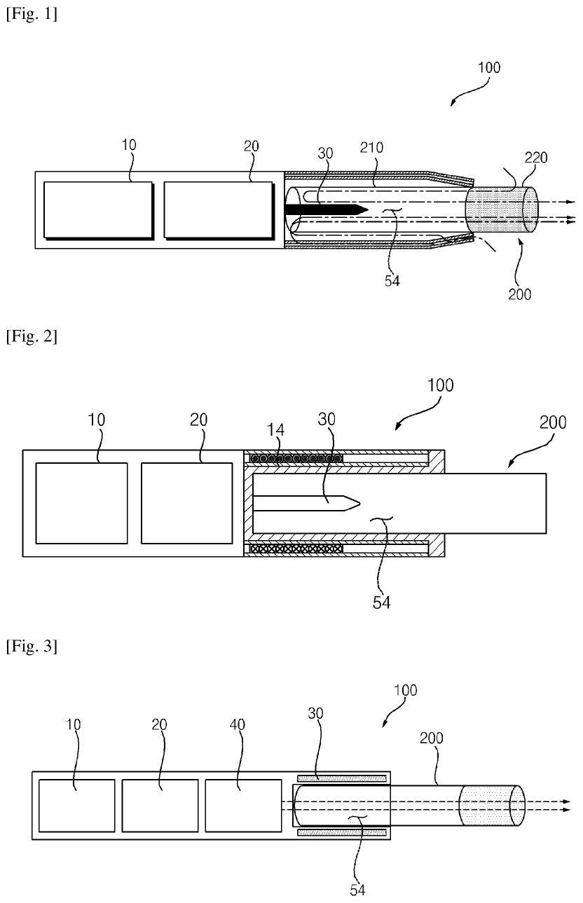

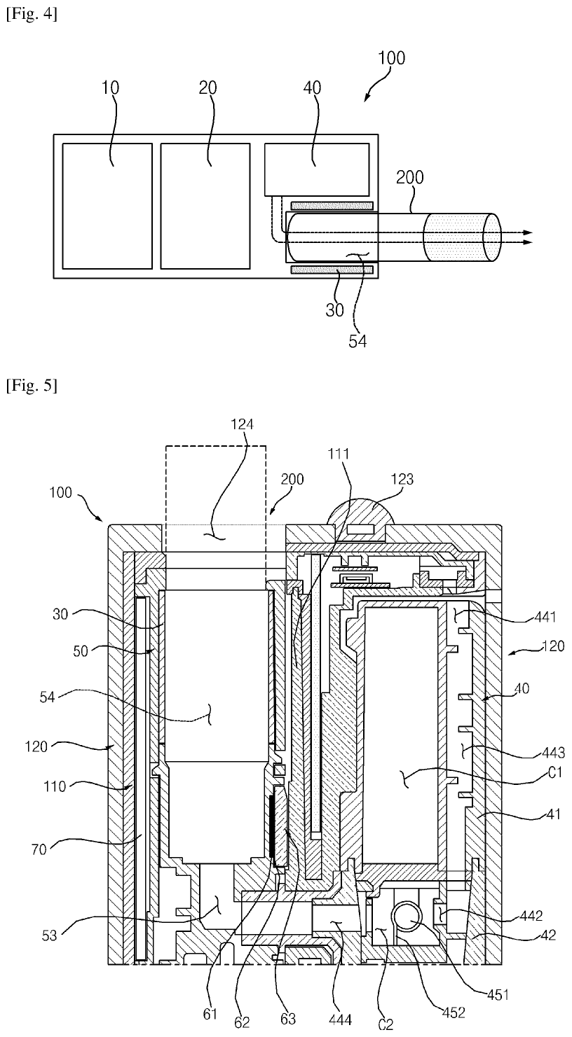

Referring to FIGS. 1 and 2, an aerosol-generating device 100 may include at least one of a battery 10, a controller 20, or a heater 30. Referring to FIGS. 3 and 4, the aerosol-generating device 100 may further include a cartridge 40.

Referring to FIGS. 1 and 2, the battery 10, the controller 20, and the heater 30 may be disposed in a line. Referring to FIG. 3, the battery 10, the controller 20, the heater 30, and the cartridge 40 may be disposed in a line. Referring to FIG. 4, the cartridge 40 and the heater 30 may be disposed parallel to each other so as to face each other. The internal structure of the aerosol-generating device 100 is not limited to that shown in the drawings.

The aerosol-generating device 100 may have an insertion space 54 defined therein. The insertion space 54 may be open in the upward direction of the aerosol-generating device 100. The insertion space 54 may have a cylindrical shape. A stick 200 may be inserted into the insertion space 54.

The heater 30 may be disposed around the insertion space 54 or in the insertion space 54. The heater 30 may heat the insertion space and/or the stick 200 inserted into the insertion space 54. The heater 30 may heat the stick 200 to generate an aerosol. The heater 30 may be an electrically resistive heater. The heater 30 may be made of a conductive metal.

Referring to FIGS. 1 and 2, the heater 30 may protrude upwards from the bottom of the insertion space 54. The heater 30 may have an elongated rod shape. The heater 30 may have a pointed top. When the stick 200 is inserted into the insertion space 54, the heater 30 may be inserted into the stick 200. Referring to FIG. 1, the heater 30 may directly generate heat upon receiving current from the battery 10. Referring to FIG. 2, an induction coil 14 may surround the heater 30 and the insertion space 54. The induction coil 14 may be wound around the insertion space 54. The heater 30 may generate heat due to a magnetic field generated by alternating current flowing through the induction coil 14. The magnetic field may pass through the heater 30 to generate an eddy current in the heater 30. The current may cause the heater 30 to generate heat.

Referring to FIGS. 3 and 4, the heater 30 may surround the insertion space 54. The heater 30 may surround the lower portion of the stick 200 inserted into the insertion space 54. The heater 30 may extend in the circumferential direction along the circumference of the insertion space 54. The heater 30 may be formed in a ring shape or a cylindrical shape. The heater 30 may directly generate heat upon receiving current from the battery 10. Although the heater 30 is illustrated in FIGS. 3 and 4 as being included in the aerosol-generating device 100, the heater 30 may not be included in the aerosol-generating device as needed.

The battery 10 may supply power so that at least one of the controller 20, the heater 30, or the cartridge 40 operates. The battery 10 may supply power required for driving a display, a sensor, a motor, etc. mounted in the aerosol-generating device 100.

The controller 20 may control the overall operation of the aerosol-generating device 100. The controller 20 may control the operation of at least one of the battery 10, the heater 20, or the cartridge 40. The controller 20 may control the operation of the display, the sensor, the motor, etc. mounted in the aerosol-generating device 100. The controller 20 may check the state of each of the components of the aerosol-generating device 100 to determine whether the aerosol-generating device 100 is in an operable state.

The cartridge 40 may store liquid therein. The cartridge 40 may generate an aerosol using the liquid stored therein. The aerosol generated in the cartridge 40 may be delivered to a user via the stick 200 inserted into the aerosol-generating device 100.

The lower end of the stick 200 may be inserted into the insertion space 54, and the upper end thereof may be exposed to the outside from the insertion space 54. The user may inhale air in the state of holding the exposed upper end of the stick 200 in the mouth. The air may pass through the aerosol-generating device 100, and may then be delivered to the user together with an aerosol.

Referring to FIG. 5, the cartridge 40 may be detachably coupled to a body 110. The cartridge 40 may be disposed parallel to a pipe 50 and/or the insertion space 54. A partition wall 111 may be disposed between the pipe 50 and the cartridge 40 to separate the pipe 50 and the cartridge 40 from each other. The partition wall 111 may be formed to be elongated in the vertical direction. The cartridge 40 may be disposed parallel to the partition wall 111.

The cartridge 40 may have therein a first chamber C1. The liquid may be stored in the first chamber C1. The cartridge 40 may have therein a second chamber C2. The second chamber C2 may be separated from the first chamber C1. The second chamber C2 may be disposed below the first chamber C1.

A wick 451 may be disposed in the second chamber C2. The wick 451 may be connected to the first chamber C1. The wick 451 may receive liquid from the first chamber C1. A heating coil 452 may be disposed in the second chamber C2. The heating coil 452 may be wound around the wick 451. The heating coil 452 may heat the wick 451. When the heating coil 452 heats the wick 451 having the liquid received therein, an aerosol may be generated in the second chamber C2.

The cartridge 40 may have a first inlet 441. The first inlet 441 may be formed in such a manner that the upper end of the cartridge 40 is open. The first inlet 441 may communicate with the outside of the cartridge 40. The cartridge 40 may have a second inlet 442. The second inlet 442 may be formed in such a manner that one side of the second chamber C2 is open, and may communicate with the second chamber C2. An inflow passage 443 may allow the first inlet 441 and the second inlet 442 to communicate with each other. The inflow passage 443 may be located between the first inlet 441 and the second inlet 442. The inflow passage 443 may extend vertically from the first inlet 441 to the second inlet 442. The inflow passage 443 may be formed parallel to the first chamber C1. The cartridge 40 may have an outlet 444. The outlet 444 may be formed in such a manner that a portion of the second chamber C2 is open, and may allow the second chamber C2 to communicate with the outside of the cartridge 40. The outlet 444 may be located opposite the second inlet 442 with respect to the second chamber C2. When the cartridge 40 is coupled to the body 110, the outlet 444 may be connected to a connecting passage 53.

The pipe 50 may be coupled to the inside of the body 110. The insertion space 54 may be defined in the pipe 50 so as to be elongated. The pipe 50 may surround the insertion space 54. The pipe 50 may be elongated in the vertical direction. The pipe 50 may be disposed parallel to the partition wall 111. The pipe 50 may be disposed parallel to the cartridge 40.

The insertion space 54 may be elongated in the vertical direction. The insertion space 54 may have a cylindrical shape. The upper end of the insertion space 54 may be open to communicate with the outside. The lower end of the insertion space 54 may communicate with the connecting passage 53. The connecting passage 53 may allow the outlet 444 and the lower end of the insertion space 54 to communicate with each other. The connecting passage 53 may be located below the insertion space 54. The connecting passage 53 may be located below the partition wall 111. The stick 200 may be inserted into the insertion space 54, and may project to the outside of the aerosol-generating device 100.

The user may inhale air in the state of holding the stick 200 inserted into the insertion space 54 in the mouth. The air may be introduced into the cartridge 40 through the first inlet 441. The air may sequentially pass through the first inlet 441, the inflow passage 443, the second inlet 442, the second chamber C2, the outlet 444, and the connecting passage 53, and may then be supplied to the stick 200 inserted into the insertion space 54. The air may pass through the second chamber C2 together with an aerosol. Both the air and the aerosol may pass through the stick 200, and may then be provided to the user.

An upper case 120 may cover the upper portion of the body 110 so as to surround the same. The upper case 120 may cover the cartridge 40. The upper case 120 may cover the pipe 50 and the insertion space 54. The upper case 120 may be detachably coupled to the body 110. An insertion hole 124 may be formed in such a manner that the upper portion of the upper case 120 is open. The insertion hole 124 may be formed at a position corresponding to the opening in the insertion space 54. The insertion hole 124 may communicate with the insertion space 54. A cap 123 may be movably mounted on the upper portion of the upper case 120. The cap 123 may move to open or close the insertion hole 124. Accordingly, it is possible to prevent foreign substances from entering the insertion space 54 from the outside and to protect the aerosol-generating device 100.

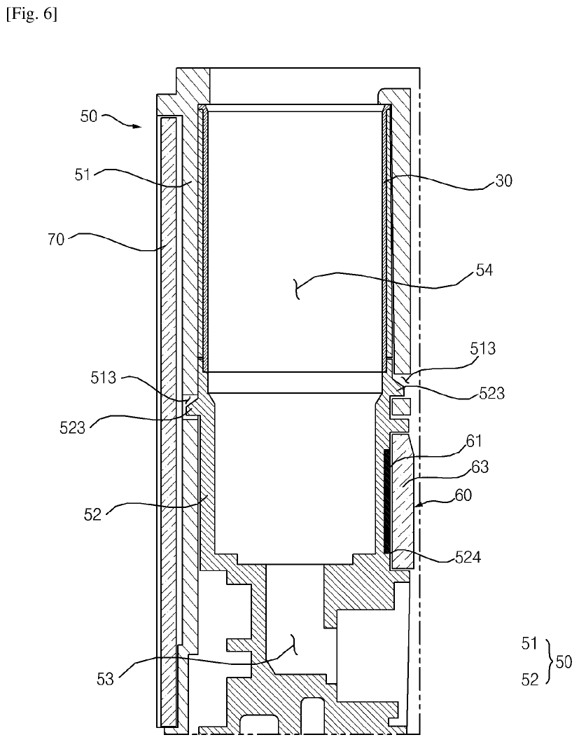

Referring to FIG. 6, the pipe 50 may include a first pipe portion 51 and a second pipe portion 52. The first pipe portion 51 and the second pipe portion 52 may be coupled to each other. For example, the first pipe portion 51 may be coupled to the upper side of the second pipe portion 52. The first pipe portion 51 may surround the upper portion of the insertion space 54. The first pipe portion 51 may be open upwards. The second pipe portion 52 may surround the lower portion of the insertion space 54. The connecting passage 53 may be formed in the second pipe portion 52.

First couplers 513 and 523 may couple the first pipe portion 51 and the second pipe portion 52 to each other. The first couplers 513 and 523 may include a first coupling hole 513 and a first coupling protrusion 523. The first coupling protrusion 523 may be inserted into the first coupling hole 513 to couple the first pipe portion 51 and the second pipe portion 52 to each other. The first coupling protrusion 523 may be coupled to the first coupling hole 513 in a snap-fit manner so as not to be separated therefrom.

For example, the first coupling hole 513 may be formed in the first pipe portion 51, and the first coupling protrusion 523 may be formed at the second pipe portion 52. In another example, the first coupling hole 513 may be formed in the second pipe portion 52, and the first coupling protrusion 523 may be formed at the first pipe portion 51. Each of the first coupling hole 513 and the first coupling protrusion 523 may be provided in a pair. The pair of first coupling holes 513 and the pair of first coupling protrusions 523 may be disposed at positions corresponding to each other.

The heater 30 may surround the upper portion of the insertion space 54. The heater 30 may have a cylindrical shape. The heater 30 may be fixed to the inside of the first pipe portion 51 of the pipe 50. The heater 30 may extend in the circumferential direction along the inner circumferential surface of the first pipe portion 51. The heater 30 may heat the upper portion of the insertion space 54. The heater 30 may be located at a height corresponding to the medium included in the stick 200 inserted into the insertion space 54. The heater 30 may heat the medium in the stick 200.

The lower end of the heater 30 may be supported by the second pipe portion 52. The inner circumferential surface of the upper end of the first pipe portion 51 may protrude inwards to cover the upper end of the heater 30. The first pipe portion 51 and the second pipe portion 52 may be coupled to each other through the first couplers 513 and 523. Accordingly, the convenience of assembly may be improved, and the heater 30 may be stably located.

A substrate 61 may cover a portion of the outer wall of the pipe 50. The substrate 61 may face the insertion space 54. The substrate 61 may be disposed at a position corresponding to the lower portion of the insertion space 54 to face the lower portion of the insertion space 54. When the stick 200 is inserted into the insertion space 54, the substrate 61 may face the lower portion of the stick 200. The substrate 61 may be disposed below the heater 30. The substrate 61 may be bent at a predetermined curvature to surround a portion of the circumference of the insertion space 54.

The substrate 61 may be adjacent to the partition wall 111 and/or the cartridge 40. The substrate 61 may face the lower portion of the partition wall 111. The substrate 61 may be disposed between the pipe 50 and the partition wall 111. The substrate 61 may be disposed between the pipe 50 and the cartridge 40. The substrate 61 may face the lower portion of the first chamber C1 of the cartridge 40. One surface of the substrate 61 may face the insertion space 54, and the other surface of the substrate 61 may face the cartridge 40.

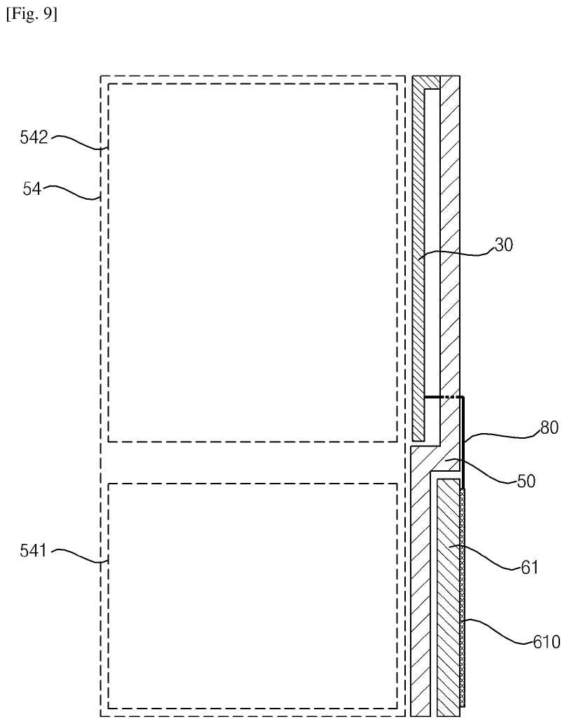

The substrate 61 may be provided with a sensor pattern 610 (refer to FIG. 9). The sensor pattern 610 (refer to FIG. 9) may be mounted on the substrate 61. The sensor pattern 610 (refer to FIG. 9) may sense electromagnetic change around the same. The electromagnetic change may occur according to change in the state of an object near the substrate 61. The substrate 61 may detect movement of a nearby object. The sensor pattern 610 may be electrically connected to the battery 10 (refer to FIGS. 1 to 4) to receive current.

The substrate 61 may detect change in capacitance around the same to detect change in the surroundings. The substrate 61 may be referred to as a capacitance sensor 61. The capacitance sensor 61 may be implemented using one of the two following sensor technologies: self-capacitance and mutual capacitance. When an object approaches the capacitance sensor 61, or when an object near the capacitance sensor 61 moves or changes in state, the capacitance sensor 61 may change in self-capacitance or electrode force between separate electrodes. Hereinafter, the present disclosure will be described on the assumption that the substrate 61 is the capacitance sensor 61.

For example, in the case of the stick 200 inserted into the insertion space 54, the amount of moisture in the lower portion of the stick 200 may vary depending on the degree of use thereof, and accordingly, the capacitance sensed by the substrate 61 may change. Accordingly, the substrate 61 may detect the extent to which the stick 200 is used, or may detect whether the stick 200 is a used stick.

For example, the capacitance sensed by the substrate 61 when the stick 200 is inserted into the insertion space 54 and the capacitance sensed by the substrate 61 when the stick 200 is not inserted into the insertion space 54 may differ from each other. Accordingly, the substrate 61 may detect whether the stick 200 is inserted into the insertion space 54.

For example, the capacitance sensed by the substrate 61 when the cartridge 40 is coupled to the body 110 and the capacitance sensed by the substrate 61 when the cartridge 40 is not coupled to the body 110 may differ from each other. Accordingly, the substrate 61 may detect whether the cartridge 40 is coupled to the body 110.

For example, the capacitance sensed by the substrate 61 may vary depending on the amount of liquid remaining in the first chamber C1 of the cartridge 40. Accordingly, the substrate 61 may detect the amount of liquid remaining in the cartridge 40.

The functions of the substrate 61 are not limited to those described above, and the substrate 61 may be utilized in various other manners, so long as the same is capable of determining the state of the surroundings through nearby elements causing change in capacitance. To this end, a lookup table indicating the capacitance values sensed by the substrate 61 and changes of the surrounding environment corresponding thereto may be stored in a memory.

The description of determination as to the state of the surroundings based on change in capacitance is merely given by way of example. The present disclosure is not limited thereto. Alternatively, the state of the surroundings may be determined by detecting electromagnetic change.

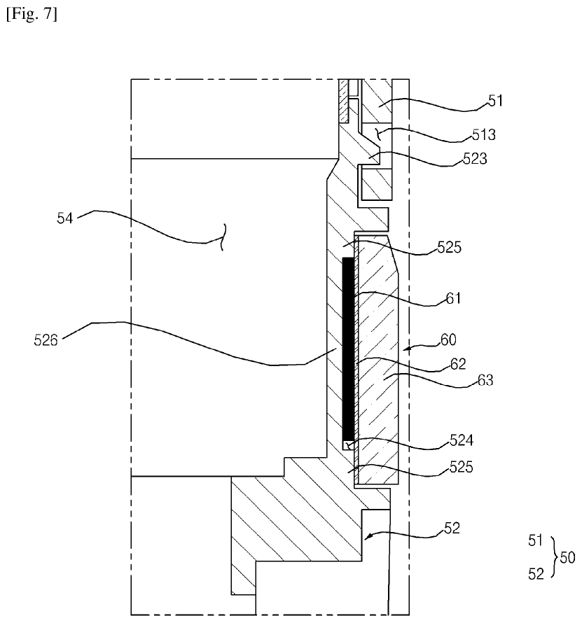

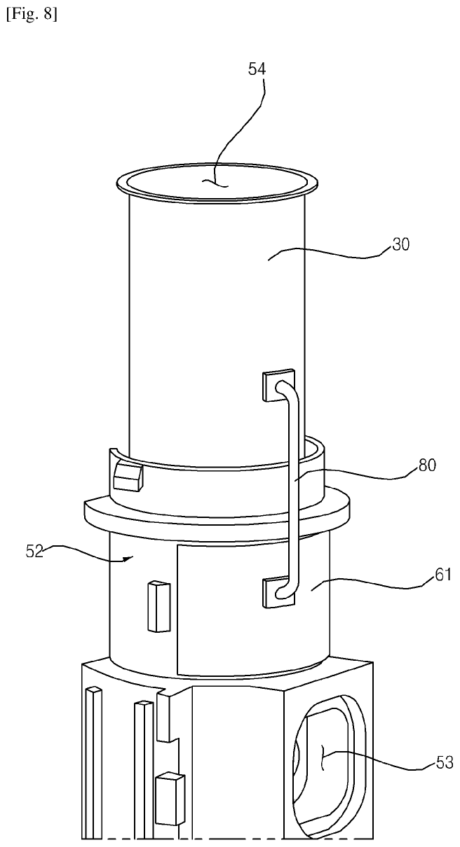

Referring to FIGS. 6 and 7, the pipe 50 may have an insertion recess 524 formed therein. The insertion recess 524 may be formed in such a manner that a portion of the outer circumferential surface of the pipe 50 is depressed or recessed toward the insertion space 54. The insertion recess 524 may be formed in one side of the second pipe portion 52. The substrate 61 may be inserted into the insertion recess 524. The substrate 61 may be fixed to the insertion recess 524 in the pipe 50.

The substrate 61 may be implemented as a flexible printed circuit board (FPCB), and may have the shape of a flexible film. The substrate 61 may cover a portion of the outer circumferential surface of the pipe 50 at a predetermined curvature. The substrate 61 may be disposed so as to cover the outer circumferential surface of the second pipe portion 52. The substrate 61 may be bent at a predetermined curvature along a portion of the circumference of the insertion space 54.

The insertion recess 524 may be formed in one side of the pipe 50 so as to be bent at a predetermined curvature along the outer circumferential surface of the pipe 50. The substrate 61 may extend in the shape corresponding to the insertion recess 524. The substrate 61 may be bent so as to surround a portion of the outer circumferential surface of the pipe 50 at a predetermined curvature. The substrate 61 may surround a portion of the circumference of the insertion space 54 at a predetermined curvature.

An elastic member 62 may cover the substrate 61. The elastic member 62 may seal the insertion recess 524. The clastic member 62 may be flexible. The elastic member 62 may be bent at a predetermined curvature so as to surround the outer circumferential surface of the pipe 50 and may be in close contact with the periphery of the insertion recess 524. For example, the elastic member 62 may be made of rubber or silicone and thus may be elastic.

A frame portion 525 may be formed so as to surround the periphery of the substrate 61 inserted into the insertion recess 524. The frame portion 525 may protrude from the circumference of the insertion recess 524. The edge of one surface of the clastic member 62 may be in close contact with one surface of the frame portion 525. One surface of the substrate 61 may be in contact with the outer circumferential surface of the pipe 50 at a position inside the insertion recess 524, and the other surface of the substrate 61 may be in contact with the elastic member 62.

The cover 63 may cover the substrate 61. The cover 63 may cover the insertion recess 524. The cover 63 may be in close contact with the elastic member 62. The clastic member 62 may be disposed between the substrate 61 and the cover 63. The elastic member 62 may be disposed between the insertion recess 524 and the cover 63. The elastic member 62 may be in close contact with the cover 63 and the frame portion 525, thereby scaling the insertion recess 524.

The cover 63 may surround a portion of the outer circumferential surface of the pipe 50 at a predetermined curvature. The cover 63 may have a shape that is bent at a predetermined curvature along a portion of the outer circumferential surface of the pipe 50. The cover 63 may be bent so as to surround the outer circumferential surface of the pipe 50.

The cover 63 and the pipe 50 may be coupled to each other by means of second couplers 527 and 634. Each of the second couplers 527 and 634 may be provided in a pair at positions corresponding to the two ends of the cover 63. The second couplers 527 and 634 may include a second coupling hole 634 and a second coupling protrusion 527. The second coupling protrusion 527 may be inserted into the second coupling hole 634 to couple the cover 63 and the pipe 50 to each other. The second coupling protrusion 527 may be coupled to the second coupling hole 634 in a snap-fit manner so as not to be separated therefrom.

For example, the second coupling hole 634 may be formed in the cover 63, and the second coupling protrusion 527 may be formed at the pipe 50. In another example, the second coupling hole 634 may be formed in the pipe 50, and the second coupling protrusion 527 may be formed at the cover 63. Each of the second coupling hole 634 and the second coupling protrusion 527 may be provided in a pair. The pair of second coupling holes 634 and the pair of second coupling protrusions 527 may be disposed at positions corresponding to each other. The pair of second coupling holes 634 may be formed in the two ends of the cover 63. The pair of second coupling protrusions 527 may be formed at positions opposite each other with respect to the insertion space 54.

Accordingly, the substrate 61 may be disposed closer to the insertion space 54, or may have an increased sensing area, whereby the accuracy of the sensor may be increased. Further, the efficiency of use of the space in which the substrate 61 is mounted may be improved. Furthermore, the substrate 61 may be protected from external foreign substances or liquid, and the structural stability thereof may be improved.

FIG. 8 is a perspective view showing the state in which the heater 30 is exposed by removing the first pipe portion 51 from the configuration shown in FIG. 6 and in which the substrate 61 is exposed by removing the cover 63 and the elastic member 62 therefrom.

Referring to FIGS. 6 and 8, the heater 30 may be formed in a cylindrical shape. The heater 30 may be formed such that a metal plate is rolled in a cylindrical shape. The heater 30 may surround a portion of the circumference of the insertion space 54. The inner circumferential surface of the heater 30 may cover the outer circumferential surface of the insertion space 54. The heater 30 may be disposed on the second pipe portion 52. The lower end of the heater 30 may be supported by the second pipe portion 52.

The second pipe portion 52 may be located between the substrate 61 and the insertion space 54. The substrate 61 may be separated from the insertion space 54 by the second pipe portion 52. The second pipe portion 52 may surround the inner circumferential surface of the lower portion of the insertion space 54. The substrate 61 may surround a portion of the outer circumferential surface of the second pipe portion 52. The heater 30 may be in contact with the insertion space 54.

The substrate 61 may be disposed at a position corresponding to the lower portion of the insertion space 54. The substrate 61 may surround one side of the lower portion of the insertion space 54. The heater 30 may be disposed above the substrate 61. The heater 30 may be disposed at a position corresponding to a region from the middle portion of the insertion space 54 to the upper portion thereof. The heater 30 may surround the circumference of the region from the middle portion of the insertion space to the upper portion thereof.

A connector 80 may electrically connect the heater 30 and the substrate 61 to each other. One end of the connector 80 may be connected to the heater 30. The other end of the connector 80 may be connected to the substrate 61. The connector 80 may be conductive.

Accordingly, the connector 80 may expand the area for sensing electromagnetic change from the periphery of the sensor to the periphery of the heater 30. This will be described later.

Referring to FIG. 9, the substrate 61 may be located at a height corresponding to a first region 541 of the insertion space 54. The heater 30 may be located at a height corresponding to a second region 542 of the insertion space 54. For example, the second region 542 may be adjacent to the upper portion of the insertion space 54, and the first region 541 may be adjacent to the lower portion of the insertion space 54. The second region 542 may be located above the first region 541. However, the first region 541 and the second region 542 are not limited thereto.

The sensor pattern 610 printed on the substrate 61 may be made of a conductive metal. The sensor pattern 610 may receive current from the battery 10 (refer to FIGS. 1 to 4), and the current may flow through the sensor pattern 610. The substrate 61 may be a capacitance sensor 61 on which the sensor pattern 610 for detecting capacitance change is printed.

The connector 80 may electrically connect the heater 30 and the substrate 61 to each other. One end of the connector 80 may be connected to the heater 30. The other end of the connector 80 may be connected to the substrate 61. The connector 80 may enable the heater 30 to function as a sensor by electrically connecting the heater 30 and the substrate 61 to each other. That is, the heater 30 may function as an extended portion of the sensor pattern 610.

The connector 80 may connect the heater 30 and the substrate 61 to each other via a channel other than the sensor pattern 610. Alternatively, the connector 80 may connect the heater 30 and the sensor pattern 610 mounted on the substrate 61 to each other. In this case, one end of the connector 80 may be connected to the heater 30, and the other end of the connector 80 may be connected to the sensor pattern 610. The connector 80 may be a wire, which is conductive, or a PCB. The PCB may be an FPCB, but the present disclosure is not limited thereto.

The heater 30 may be a resistive heater. The heater 30 may generate heat upon receiving current from the battery 10 (refer to FIGS. 1 to 4). The resistance of the sensor pattern 610 and the amount of heat generated thereby may be less than those of the heater 30. The connector 80 may be made of the same material as the sensor pattern 610.

The heater 30 may be made of a conductive metal. The heater 30 may be formed such that a metal plate is rolled in a cylindrical shape. For example, the heater 30 may be made of a stainless material, but the present disclosure is not limited thereto. One end of the connector 80 may be soldered to the heater 30.

In another example, the heater 30 may be formed such that a heating pattern is printed on a PCB. In this case, for example, the PCB may be an FPCB. In this case, an end portion of the connector 80 may be electrically connected to the heating pattern printed on the PCB.

Accordingly, the connector 80 may expand the area for sensing electromagnetic change from the periphery of the sensor pattern 610 mounted on the substrate 61 to the periphery of the heater 30. That is, the area for sensing electromagnetic change may be expanded from the second region 542 to the first region 541.

In addition, sensing channels for sensing electromagnetic change may be separated. For example, the substrate 61 may detect change in the humidity of the lower end of the stick 200 in the first region 541, and the heater 30 may detect whether the stick 200 is inserted into the insertion space 54 in the second region 542. In another example, it is possible to more accurately detect the extent to which the stick 200 is used or whether the stick 200 is a used stick based on the difference between the amount of moisture in the stick 200 sensed in the first region and the amount of moisture in the stick 200 sensed in the second region 542.

In addition, the heater 30 may be disposed in the pipe 50, and thus the inner circumferential surface of the heater 30 may be in contact with the outer circumferential surface of the insertion space 54. Accordingly, the efficiency of conduction of heat from the heater 30 to the stick 200 may be improved. In addition, since the heater 30 is located closer to the outer circumferential surface of the stick 200, sensing sensitivity may be improved.

Meanwhile, referring to FIG. 2, the connector 80 may connect the substrate 61 to the induction coil 14, rather than to the heater 30. In this case, the connector 80 may expand the sensing area to a region surrounded by the induction coil 14. Since this has been described above, a detailed description thereof will be omitted.

Referring to FIGS. 1 to 9, an aerosol-generating device in accordance with one aspect of the present disclosure may include a pipe configured to define an insertion space; a heater configured to heat the insertion space; a substrate having a sensor pattern mounted thereon which is configured to sense an electromagnetic change of a surrounding region; and a connector configured to electrically connect the heater and the substrate.

In addition, in accordance with another aspect of the present disclosure, wherein the connector may allow the heater to sense electromagnetic change of a surrounding region of the heater.

In addition, in accordance with another aspect of the present disclosure, wherein the heater may have a cylindrical shape to surround the insertion space.

In addition, in accordance with another aspect of the present disclosure, wherein the heater may be positioned inside the pipe to surround the insertion space.

In addition, in accordance with another aspect of the present disclosure, wherein the substrate may be disposed at a portion of an outer wall of the pipe.

In addition, in accordance with another aspect of the present disclosure, wherein the substrate may be disposed at a position corresponding to a lower portion of the insertion space, and wherein the heater may be disposed at a position corresponding to an upper portion of the insertion space.

In addition, in accordance with another aspect of the present disclosure, wherein the pipe may comprise an insertion recess at an outer circumferential surface thereof, and wherein the substrate may be disposed in the insertion recess.

In addition, in accordance with another aspect of the present disclosure, the heater may be a resistive heater made of a metal.

In addition, in accordance with another aspect of the present disclosure, the connector may be a conductive wire or a printed circuit board (PCB).

In addition, in accordance with another aspect of the present disclosure, wherein the sensor pattern mounted on the substrate may be configured to detect change in capacitance around the substrate.

In addition, in accordance with another aspect of the present disclosure, an aerosol-generating device may include a pipe configured to define an insertion space; a heater protruding from a bottom of the insertion space and configured to heat a stick inserted into the insertion space; an induction coil wound so as to surround the insertion space at a position corresponding to the heater, and configured to cause the heater to generate heat; a substrate disposed on one side of the pipe and having a senor mounted thereon which is configured to sense electromagnetic change of a surrounding region; and a connector configured to electrically connect the induction coil and the substrate, wherein the connector allows the induction coil to sense electromagnetic change of a surrounding region of the induction coil.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a pipe configured to define an insertion space;
a heater configured to heat the insertion space;
a substrate having a sensor pattern mounted thereon which is configured to sense an electromagnetic change of a surrounding region; and
a connector configured to electrically connect the heater and the substrate,
wherein the connector allows the heater to sense electromagnetic change of a surrounding region of the heater.

2. The aerosol-generating device according to claim 1, wherein the heater has a cylindrical shape to surround the insertion space.

3. The aerosol-generating device according to claim 2, wherein the heater is positioned inside the pipe to surround the insertion space.

4. The aerosol-generating device according to claim 1, wherein the substrate is disposed at a portion of an outer wall of the pipe.

5. The aerosol-generating device according to claim 4, wherein the substrate is disposed at a position corresponding to a lower portion of the insertion space, and
wherein the heater is disposed at a position corresponding to an upper portion of the insertion space.

6. The aerosol-generating device according to claim 4, wherein the pipe comprises an insertion recess at an outer circumferential surface thereof, and
wherein the substrate is disposed in the insertion recess.

7. The aerosol-generating device according to claim 1, wherein the heater is a resistive heater made of a metal.

8. The aerosol-generating device according to claim 1, wherein the connector is a conductive wire or a printed circuit board (PCB).

9. The aerosol-generating device according to claim 1, wherein the sensor pattern mounted on the substrate is configured to detect change in capacitance around the substrate.

10. An aerosol-generating device comprising:
a pipe configured to define an insertion space;
a heater protruding from a bottom of the insertion space and configured to heat a stick inserted into the insertion space;
an induction coil wound so as to surround the insertion space at a position corresponding to the heater, and configured to cause the heater to generate heat;
a substrate disposed on one side of the pipe and having a senor mounted thereon which is configured to sense electromagnetic change of a surrounding region; and
a connector configured to electrically connect the induction coil and the substrate,
wherein the connector allows the induction coil to sense electromagnetic change of a surrounding region of the induction coil.
